(19) United States
(12) Patent Application Publication
(10) Pub. No.: US 2016/0078853 A1
(43) Pub. Date: Mar. 17, 2016

(54) Facilitating Online Access To and Participation In Televised Events

(71) Applicant: Creighton Strategies Ltd.

(72) Inventors: Andrew A. Gonczi, Wesley Chapel, FL (US); Károly Nehéz, Miskolc (HU); András Zboray, Budapest (HU)

(21) Appl. No.: 14/852,346

(22) Filed: Sep. 11, 2015

Related U.S. Application Data
(60) Provisional application No. 62/049,825, filed on Sep. 12, 2014.

(51) Int. Cl. G10H 1/36; A63F 13/335; A63F 13/798

(52) U.S. Cl. CPC G10H 1/365; G10H 1/368; A63F 13/798; A63F 13/335; G10H 2220/011

(57) ABSTRACT

Computer-implemented management of a distributed televised and/or online entertainment events and contests involves using a contestant module executing on a mobile device with the facility to record an audio-visual performance by a contestant associated with the mobile device; via a communications network, transmitting the recorded audio-visual performance from the contestant module executing on the mobile device to a producer module executing on a computer system remote from the mobile device; evaluating the recorded audio-visual performance to determine whether it satisfies one or more predetermined criteria; if the recorded audio-visual performance is determined to satisfy the one or more predetermined criteria, making the recorded audio-visual performance available for viewing by an audience; receiving, from viewer modules executing on respective audience member devices, votes relating to the recorded audio-visual performance; and determining a winner of the distributed online contest based at least in part on the received votes.

### RELATED APPLICATION

This application claims priority to U.S. Provisional Application No. 60/049,825, filed Sep. 12, 2014, the contents of which are incorporated by reference.

### BACKGROUND & SUMMARY

This document relates to facilitating online access to, and participation in, televised events (e.g., either conventional broadcast TV, cable TV or IP TV), which can be used for many different purposes including, for example, remote participation in televised live talent contests, e.g., by conducting and managing a live and/or media-distributed song contest or other entertainment event by combining traditional television programming with software installed on Internet-connected devices in order to generate and manage content from a plurality of sources.

In various implementations, the subject technology embodies a novel combination of traditional talent quest format programs enhanced by the inclusion of technological elements embodying computer functionality and mobile data communication and devices, which in combination facilitate operating a televised or online broadcast entertainment event, such as a talent contest, through enhanced audience participation and a simplified audition process for contestants to record and submit their entries for judging.

In some implementations, the technology described here manifests as a means of conducting and managing karaoke events and other performance arts, in the context of the western form of “talent quest” style events whether these are conducted live, transmitted real time or transmitted after a time-shift, with the addition of a digital processing system that enables smartphones and comparable internet connected devices to record and submit audio and video captures of their performances by those wishing to have their performance considered in the subject competition or event (“Contestants”) and those wishing to share these performances with others observing the event (“Viewers”) and those tasked with evaluating, storing, distributing and managing those submissions (“Administrators”) within the competition infrastructure and to external users such as broadcast and internet-borne media.

Although referencing karaoke, or more generally song contests, the subject technology has application for a plurality of other art or talent forms where a combination of audio and video presentation may be necessary or beneficial, including dramatic and comedic performances, juggling and other feats of physical balance or dexterity, legerdemain and dance, be it with one or a multiplicity of participants (“Performances”)

In most talent shows, there is a complex process for intending participants to apply to become a Contestant. Usually this requires an in-person audition and a selection process for the show's producers to assess each would-be contestant, in order to assess each person's actual talent, suitability for the particular format and to ascertain any legal impediments to that person's contracting with the show's producers to provide the performer's talent and/or services.

In some instances, producers may become aware of a potential Contestant via some third party product or service but the Contestant must then attend a television studio to record a broadcast-quality performance. If the potential Contestant cannot attend the studio, that person's Performance is effectively precluded from being included in the program or from competing where that is relevant.

In developed countries, the process of attending an audition may be relatively easy if the would-be Contestant is physically located in a place contiguous to where the audition is to be held or is able to go to the audition.

However, for would-be Contestants who live in physically remote areas or who are unable to travel (e.g. persons with a physical impediment or health issue), these people may be precluded from contesting regardless of their talent or skill, where physical presence is a prerequisite for consideration in an audition process.

In countries where the transport infrastructure is not well developed or is expensive compared to the prevailing income levels or where travel is dangerous for either physical or social reasons, this may preclude would-be contestants from physically participating in auditions and therefore they miss the opportunity to be considered and this introduces undue inequality as the ability to participate may be dependent on financial means.

In countries where much of each country's population is spread across a wide geographic area or is located on many islands and where the GDP per capita is low, such as the Philippines, Indonesia and other developing economies, a significant part of the population includes many persons with talent and for whom karaoke is a popular form of entertainment.

Many potential Contestants are precluded from competing in talent shows because they cannot afford the time or the money required to make attend auditions in person, particularly where the audition locales are distant but attendance is prerequisite to participating in the audition process.

In recent years many people have changed their consumer behavior by using internet based systems for gaining information and communicating with others rather than from television and centralized media. With the increased use of so-called smartphones (typical components of which include a camera for capturing images and/or video of the smartphone's user, a microphone for capturing sound associated with the user, a display screen for displaying images and video, a speaker for playing sounds, and a cellular and/or WiFi transceiver for communicating with a data network) a significant portion of the population in countries with internet access via telephones and other portable computing devices, use their internet connected devices to interact with the world.

In recent years, productions such as “The Voice,” “America's Got Talent,” and comparable talent shows produced around the world, have achieved wide media coverage when “unlikely” persons win the event. In this context “unlikely” means a person whose background, appearance, style or the like is atypical for a performer on mainstream media. In the UK, for example, Susan Boyle won a nationally televised production and went on to become a top selling recording artist in many countries. Similarly, Paul Potts and Andrew Johnson, both atypical contestants relative to the other contestants, were finalists in a nationally telecast talent show and both went on to sell many records and to become successful entertainers in their own right.

These talent shows frequently use a “rags to riches” narrative to attract viewers, yet the physical and financial demands for attending auditions may preclude many who may be regarded as falling within the economically poorest groups or places.

Another large segment of the population are largely disconnected from traditional centralized media such as television and radio, relying on their internet connected devices for information about events and activities.

The traditional audition process therefore limits the potential talent pool for the producers and also tends to remove the element of spontaneity from the process. A person considering becoming a Contestant likely knows, or will find out, that they are likely to have to work through a protracted and possibly expensive process in order to complete the audition process. This is likely to deter many from pursuing the issue.

Contestants attending an audition in person may have to forego important daily obligations, such as attendance at work or family commitments, in order to attend, and if they do attend they may suffer negative consequences for an uncertain future benefit (i.e., potential participation in the contest).

In traditional talent shows the audition process is the single point of entry. Yet as the show gains popularity and viewership, additional talent, sometimes more capable than those already auditioned, may become interested in participating in the event. For talented singers some of the most common exclamation on hearing televised talent show finalists is “I can sing better than that,” however the closed audition process does not allow for a demonstration of this at later stages of the contest.

In light of the foregoing and other factors, the inventors therefore recognized a need for technology that facilitates intending Contestants to apply to participate in talent shows and the like, despite barriers such as distance or lack of resources and, if the application is successful, then that person can participate in that event.

The inventors also recognized a need to widen the pool of potential and actual Contestants for a show, and also to operate a process for evaluating potential Contestants, to maintain a level of performance appropriate to the relevant program's format and its audience's expectations.

The inventors also created a way for talent to be able to challenge incumbent Contestants not only during the audition process, but also at the later elimination stages of the show. This allows “fast tracking” for outstanding talent, but also creates an element of suspense and/or surprise lacking in other talent shows, where the shows have a predictable pattern and outcome.

The inventors also created a way for one of the most time consuming, and potentially limiting factors of any audition process, which is the need to review multiple submissions, the vast majority of which will not meet expected standards. Online auditions just multiply the problem, by lowering the entry barrier. In order to discover true talent among tens of thousands (or even millions) of applications, the initial screening process requires audience participation through social media to distribute the load.

To address the aforementioned needs and deficiencies in televised talent show management, the inventors designed the subject technology with distinct modules to address the individual requirements.

Also, in one or more implementations, the subject technology set out herein provides viewers with the ability to have real-time interactivity with a live or electronically transmitted event, enabling the viewers to participate in judging or selecting a short list of Contestants from a multiplicity of applicants.

The subject technology may be used to solve this logistical problem by means of a system operated on readily available devices such as so-called smartphones, tablets and computers (“Devices”).

In one or more implementations, the subject technology includes software having several modules. Each module has a specific functionality, and the modules interact with each other. The core modules are (A) Contestant Module, enabling contestants to record and submit contest entries, (B) Voter Module, enabling audience to vote for favorite Contestants & performances, and (C) Producer Module, specific to each Contest, to receive, store and display performances and collect, count and display votes and rankings

One module is for would-be Contestants. This module (the Contestant Module) is loaded onto the relevant end-user device. Once so installed, the outputs from the Device's video camera and sound recording functions are captured as a function of the software to enable the Device to produce a specifically encoded high quality audio-visual recording. Encoding is an industry-standard codec to compress the signal to facilitate transmission from the Contestant's device to the Producer Module.

The software in the Contestant Module provides functionality to control the Device so as to produce Studio quality recordings, thus obviating the need for Contestants to attend recording sessions or auditions in person. In this context, “studio quality” means an audio-visual or audio-only recording with sufficient fidelity to render the recording of such quality for it to be broadcast or telecast or otherwise distributed for evaluation and/or presentation to the audience without further augmentation or sonic manipulation.

A different module (the Voter Module) is for persons who do not wish to be Contestants but who wish to participate in the program or event by way of voting or otherwise selecting Contestants from a multiplicity of entries.

Would-be Contestants use the Contestant Module to capture their Performance as a high quality audio-visual recording. That recording may then be submitted, together with requisite data (e.g., Contestant-provided biographical and other information about the Contestant and about the performance) embodied in the relevant recording relating to that particular Contestant, to the Producer's Module associated with the relevant Contest, to ensure that no recording can be used for another contest. The recording may only be transmitted to one selected Producer Module associated with the chosen Contest.

Requisite data may include information (e.g., name, address, demographic information) about the Contestant together with materials including contracts and consents as may be required under the laws that govern the particular contest or event and/or locality associated with the Contestant.

The Contestant Module may be associated with a particular production or event by the display of trademarks or livery or other means of branding of the Contestant Module By way of example, entries for “RisingStars Philippines” would be branded as relating to that contest, whereas entries for “RisingStars India” would be branded as relating to the latter contest. If a contest is endorsed by or associated with a third party brand or product, that third party's brand or trademark may also be embodied in the recording.

The Contestant Module and Voter Module interacts with another element of the subject technology, “the Producer's Module.” The Producer's Module is installed upon a computer (e.g., a server computer at a location remote from the user devices and communicatively coupled to the user devices via a wide-area network such as the Internet) operated by or for the producers of the relevant production or event.

The Contestant Module, Voter Module and the Producer Module are connected over the Internet (or other wide-area network) or over a telephone system or via a local area network or comparable system regardless of the frequency spectrum or technology utilized to connect the devices.

In various implementations, the subject technology integrates real-time interactivity with the ability to record a performance on a Device and for that recording to be submitted to the applicable Producer Module for consideration and evaluation in order to facilitate the audition process and also to facilitate public interaction with a live event or and electronically transmitted production. By way of example, a Contestant's entry may be forwarded to one or more persons acting as a judging panel for evaluation and that same recording may also be made available to the viewing public via the Voter Module and/or via broadcast media such as conventional television or internet television. This may be contemporaneous or time-shifted.

The subject technology also may automate many of the processes involved in collecting, evaluating and distributing recordings of Performances by collecting and systemically processing that data for use by the operators of the subject technology. By way of example, each Contestant's entry can be sorted by allocation of a unique identifier and being logged into a database to record “metadata”—being information such as the time the entry is received, the region from where it was received, whether the relevant Contestant has previously submitted an entry or entries, the nature of the entry (e.g., based upon the data provided with the entry), the title of any musical or literary work embodied in the entry and salient details to assist and simplify the process of evaluating each entry for suitability for inclusion in other media or other processing, depending upon the format of the competition.

The Voter Module may omit (or disable) the functionality of being capable of recording a performance but may enable the relevant Device to connect to the Producer's Module in order to register votes or other forms of interaction between the Voter Module and the Producer's Module.

In one or more implementations, the Contestant Module enables the relevant Device to make an audio or audio-visual recordings of a performance similar to the recording of a Karaoke performance (e.g., the Device plays a song minus the vocal track through its speaker, and then records, via the Device's microphone, the Device's user singing along to the song).

In another implementation, the module would offer to the Contestant a pre-determined selection of instrumental backing tracks which the Contestant may replay while recording their own vocal performance.

A Contestant may then record his/her/their own version of a song (the “Contestant's Recording”) from a selection of songs using one of the pre-recorded backing tracks installed within the Contestant Module.

The recording capability may include video recording of the performance, recorded via the Device's built-in or external camera where applicable.

The Contestant Module interfaces with the Producer's Module to enable a Contestant to send a recording to the Producer's Module. The Contestant's Recording may be a means of entering a competition or it may be a Contestant's submission for appraisal as a prerequisite or being accepted as a contestant (for example, to enable the producers of the event to ascertain whether the would-be contestant has the requisite skill or lack thereof).

The subject technology also may facilitate the registration of the would-be Contestant's registration, Contestant's Recording as well as more efficient management of that information within the Producer's Module. For example, where there are many entries, the process of evaluating each entry is facilitated by being able to group like or similar performances via the “metadata” generated from the information provided by the Contestant. In some competitions, the rules may contain conditions precedent, or parameters which exclude certain persons from competing or submitting an entry. Reference to the metadata assists assessment of whether the Contestant has abided by the contest rules or should be disqualified or permitted to compete.

In the case of an intending Contestant's submitting a recording of a Performance, the producer may evaluate any Contestant's Recording at a time most suitable to the producer, in order for the producer and/or judges to evaluate whether that particular Contestant has the requisite performance skills to meet the contest's or the producer's criteria.

Among other advantages, this technology and process allows a multitude of persons to submit Contestants' Recordings to the specific Producer Module for evaluation or to be made available to Voter Modules.

The system also may perform various administrative tasks including logging each submission, each Contestant's recording, data regarding each Contestant and submission-times, as well as logging the Contestant's IP address. Recording the IP address allows monitoring of the process in order to monitor compliance with relevant audition and competition rules. Recordation of the IP address as part of the metadata related to the particular entry facilitates evaluation of each entry's eligibility for the relevant contest where, for example, the contest is open to persons from a particular country.

In another implementation of the system, the contest rules may require that Contestants record a pre-determined specific song or Performance resulting in all Contestants recording their own version of the one song or Performance. This enables Voters to choose from a range of broadly comparable Performances.

In another implementation of the system, contest rules may be specified whereby Contestants may enter a contest by challenging incumbent contestants within the proscribed time frame as set out in the contest's rules, to submit their own recording (“a Challenge Entry”) with the intention that their Challenge Entry is to be compared with the existing or new performance of an incumbent Contestant (the “reference Performance”). This Challenge Entry may then be submitted to the relevant Voting Modules so that votes can be logged by viewers as to whether or not they prefer the Challenge Entry to the Reference Performance.

In another implementation, a Contestant may use the Contestant Module to make a recording in response to a specific prompting or message within a television or internet distributed entertainment production. This suits productions where immediate interaction with the audience is sought, such as competitions and talent quests. For example, if a member of the audience watches an incumbent Contestant and feels he or she or they could sing or otherwise perform the song as well or better than the performance of the incumbent Contestant being broadcast (the “Incumbent”), the Challenger may record and submit a Contestant's Recording and “challenge” the Incumbent. Depending on the event/show's format and rules, the challenge may be broadcast live in real time, with live or online audience being able to vote immediately on the Challenger or Incumbent or the Challenger's Recording may be archived to allow for later assessment by the producers.

In another implementation of the “challenge” format, a Competitor's recordings may be presented alongside the Incumbent's performance so as to enable viewers to observe the two (or more) simultaneously and thereby to compare the versions. This may be the basis for a competition or for some selection process. Where this is a competition, this may involve the Voter Module as the means of collecting and collating votes.

Apparatus, methods and/or computer-readable non-transitory media embodying machine instructions may be configured to manage a distributed online contest as follows: using a contestant module executing on a mobile device to record an audio-visual performance by a contestant associated with the mobile device; via a communications network, transmitting the recorded audio-visual performance from the contestant module executing on the mobile device to a producer module executing on a computer system remote from the mobile device; evaluating the recorded audio-visual performance to determine whether it satisfies one or more predetermined criteria; if the recorded audio-visual performance is determined to satisfy the one or more predetermined criteria, making the recorded audio-visual performance available for viewing by an audience; receiving, from viewer modules executing on respective audience member devices, votes relating to the recorded audio-visual performance; and determining a winner of the distributed online contest based at least in part on the received votes.

In one or more implementations, a method is performed by one or more processes executing on a computing device having at least a speaker, an audio jack (e.g., a headphone jack), and a display screen. The method includes various combinations of the following steps. Alternatively, or in addition, a non-transitory medium includes computer-readable instructions that when executed by a computer system cause a method to be performed that includes various combinations of the following steps.

The method may include receiving a selection of a pre-recorded audio track displayed on the device's display screen, playing the selected pre-recorded audio track through the device's audio jack and not through the device's speaker, simultaneously with the playing, capturing an input audio track through a microphone associated with the device, and combining the captured input audio track and the pre-recorded audio track in a time synchronized manner to generate a combined audio recording.

Playing the selected pre-recorded audio track through the device's audio jack may involve playing the selected pre-recorded audio track through headphones connected to the device's audio jack.

The method may further include entering a talent contest by transmitting the combined audio recording to a remote server via the Internet.

Combining the captured input audio track and the pre-recorded audio track in a time synchronized manner may involve synchronizing the captured input audio track with the played pre-recorded audio track such that an utterance in the captured input audio track is matched with a portion of the pre-recorded audio track that was playing at a same time as the utterance was made. The combining may occur after the input audio track has been captured or may occur at least in part simultaneously with capturing of the input audio track.

The microphone associated with the device may be a microphone integrated into the device, or may be an external microphone connected to the device.

The device may further include a transceiver, and the method may further include transmitting the combined audio recording to a remote computer system as an entry into a talent contest.

The method may further include, simultaneously with playing the pre-recorded audio track, displaying scrolling lyrics on the device's display screen such that the displayed lyrics and the pre-recorded audio track are time synchronized.

The method may further include, simultaneously with capturing the input audio track, capturing an input video track using a camera associated with the device. In that case, the combining may include combining the captured input audio track, the captured video track, and the pre-recorded audio track in a time synchronized manner to generate a combined audio-visual recording, which may be submitted to a remote server as an entry to a talent contest or the like.

### DESCRIPTION OF DRAWINGS

FIG. 1 is a block diagram of a system that can be used to manage distributed contests.

FIG. 2 is a flowchart of a process for capturing a performance by a participant.

FIG. 3 is a flowchart of a process for managing a distributed online contest.

FIGS. 4A-4H are exemplary screenshots of a GUI that may be used to implement the subject technology.

FIG. 5 is a diagram of a technological environment in which the disclosed subject matter may be implemented.

Like reference symbols in the various drawings indicate like elements.

### DETAILED DESCRIPTION

Talent quests have been a part of the entertainment industry for many years. In recent years, talent quests of various kinds and formats have become a staple of television programming. Productions such as “The Voice,” “America's Got Talent,” and the like have become commercial and cultural successes and generate revenues for the producers and the broadcasters associated with them as well as being a place for new talent to be seen by a large audience. Television programming is suffering worldwide from a phenomenon whereby the young “selfie” generation no longer watches traditional media, gaining many of their social cues and information interactively via online devices and so-called social media platforms.

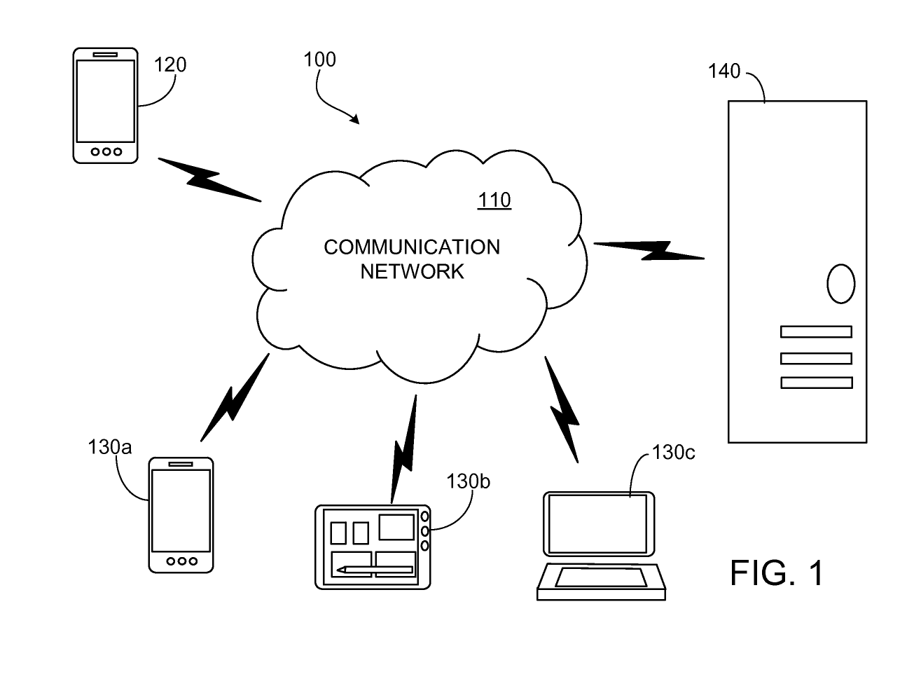

FIG. 1 is a block diagram of a system 100 for managing distributed contests. In the manner described below, the system 100 allows real time communication and interaction among the various components (e.g., network 110, contestant module executing on one or more contest mobile devices 120, producer module and administrator module, both executing on producer computer system 140, and viewer modules executing on viewer devices 130a, 130b, 130c) to facilitate the submission and evaluation of recorded performances, selectively airing or otherwise making them available for audience viewing (e.g., either on devices 120, 130a-c, or on broadcast or internet TV, or any combination thereof), receiving audience votes on the performances in response (e.g., either via devices 130a-c or a web-browser executing on a smart TV (not shown)), and then determining one or more winners of the contest based at least in part on the received votes. Alternatively, or in addition, the determination could involve determining whether the user's associate with submitted performances are suitable (e.g., good enough) to participate in the contest in the first instance.

In one implementation of the subject technology, selected pre-recorded or live to air performances of persons such as singers or other performances may be shown to an “audience” (this being, in the case of television broadcast audiences, viewers of the program; and in the case of a live event, the attendees and any other persons with access to a real-time transmission of the event via radio, television or internet).

Producers of a talent contest must determine the format and rules for the contest and make these available to the public and to intending competitors in the Contestant Module with a clickable link. Contestants shall be required to accept said rules by ticking an acceptance of rules box prior to submitting any contest entry.

The event or program's producers may deploy a version of the subject technology by way of customized versions of each of the Competitor Module and the Voting Module. Customizing in this instance could involve inclusion in one or all modules of specialized livery and get-up (e.g., visual appearance), including logos and other distinguishing features to make it clear to users that these visual elements are associated with a specific event or program. The producers may decide to distribute such modules through one or more generic or event-specific websites, or to distribute through generic application distribution channels (e.g., Google play, Apple's iStore) The branded versions of the modules are deployed containing the livery and get up (e.g., costumes, insignias, logos, etc.) associated with the relevant event or program so as to particularize the Competitor and/or Voter Module under consideration.

Each copy of each Module (whether Competitor or Voter) so distributed, contains code so as to enable the module to connect directly to a centralized computerized system accessible by specific persons (typically event producers or people appointed by them to administer the various submissions received from Competitor Modules this being the “Producer module. Typically the Producer Module will be connected to Competitor and Voter Modules via the Internet.

The Contestant module contains software that enables any device onto which the Contestant Module has been correctly installed, to make a high-quality audio-visual recording using built-in or externally connected video and audio recording hardware and to encode and/or encrypt that recording so it is readily re-playable only on the Subject System, and not by other software or hardware components. Such encryption is achieved through the incorporation of commercially available encryption software to all modules of the Subject System, producing audio-visual recordings that are only re-playable if in possession of the encryption key provided by the Producer Module at time of re-playing. In practice, this means that the audio-visual files created by the Contestant Module cannot be copied from the user device to be re-played by any other software or equipment.

The Contestant module, at the Contestant's instigation, will transmit a copy of that encoded recording, together with data identifying the Contestant and the recording (e.g., name, age, other biographical information as required by the contest rules, title of performance and any other data, to the Producer Module associated with the Contest, and acknowledge receipt of the recording by the Producer Module. If the recording is technically defective (e.g., garbled or otherwise unplayable), the Producer module can be made to send an appropriate signal to the Contestant module, alerting the Contestant so that they may re-submit that or another Performance.

Each Performance received by the Producer Module is stored and processed in accordance with the contest rules. For example, this may involve the Performance being broadcast as soon as technically possible after it has been submitted, or it may be subjected to an evaluation process (e.g., by human producers), or it may be propagated to, for example, a web site where it may be viewed by the general public or by a limited class of persons able to access that site.

The producer may at any time cause a message to be sent via the Producer module to any or all of the connected Voter Modules, to the effect that there are new or particular Performances available for viewing and/or evaluation.

Persons with access to Devices upon which the Voter Module is correctly installed, may then access those Performances as determined within the Voter Module. This may be by way of displaying the Performance on the Device itself or by directing the Voter Module to an internet address, or by another avenue for viewing the performance (e.g., to a particular TV channel).

The Producer module incorporates a functionality for votes and/or comments to be submitted in relation to any or all Performances via the Voter Module. These are received at the Producer module and are processed as determined by the competition or event's rules. This may involve votes being tallied or Competitors' Submissions being presented for votes to be submitted via the Voter Modules.

Each such submitted Performance may be identified with a shortened URL or other unique identifier which is simultaneously transmitted to the Voter module or included in a television broadcast or displayed on a screen or projection device to enable persons without the Voter module installed on their Device to participate in the voting system. The code may be written in text or presented via a so-called QR code, bar code or other media which would enable the Device to connect to the relevant Performance hosted on the Producer module.

In one implementation of the system, where the audience is participating in the event by both observing the event or contest and also participating by submitting Performances, the audience may be invited to submit their Competitor Recording via the Competitor Module as part of the subject technology. Contestants may use the subject technology on their Device to record and transmit the submitted Competitor Recording/s to the relevant Producer Module. The Performance is then processed in accordance with the relevant event or contest rules.

In other systems, the Contestant has to record their Performance using the Device's speaker playing the music in the background. Because the device is recording (along with the Competitor's voice) music and/or other sounds being played from the speaker of the same device, this method of recording a voice track combined with a music track tends to have inferior sound quality. This may be because a device typically is not designed to record sound from its own speaker. Among other advantages, the subject technology may be used to minimize or completely eliminate this issue.

In contrast to the conventional recording method, in the Contestant Module the software can enable the relevant Device to record and synchronize the Contestant's vocal Performance with pre-set music and/or a video backing (this is provided via the Contestant Module) simultaneously with the music being played on a standard Device headset. For example, if the Competitor decided to submit a Performance, first the Competitor would plug his or her headphones into the device. Ideally, the headphones would have sufficient sound insulation such that the played sounds do not bleed or otherwise emanate from the headphones as ambient noise, which could be picked up by the Device's microphone, thereby contaminating the recording of the Competitor's voice by the Device's microphone. The Device's user interface would display a list of songs from which the Competitor could choose. Once chosen, the Device would starting playing the chosen song and could optionally display the lyrics of the chosen song, along with a moving indicator synchronized with the music to visually cue the Competitor as to which word should be sung at which point in the musical stream. At the same time, the Competitor would start singing the chosen song in synchronization with the song's being played through the Device's headphone jack, through the headphone's and into the Competitor's ears. Because the headphones effectively insulate the Device's microphone from hearing the music being played through the Device's headphones, the Device's microphone would pick up only the Competitor's voice (potentially along with any other ambient noise, which ideally should be kept to a minimum) and not the music being played through the Device's audio jack.

Once the Competitor's voice track has been recorded, or substantially simultaneously with its recording, the Device executes an audio mixing process integrated into the Competitor Module to mix the captured voice track and the pre-recorded music track into a single performance track. This mixing requires an automated or user controlled synchronization step, as due to hardware limitations in simultaneously processing audio display (headset), audio recording (microphone) and video recording (camera) a timing uncertainty will be introduced by all devices (measurable in tens of milliseconds), resulting in repeated re-mixings of the same recordings of the same devices producing a variation in synchronization. For users with average hearing an automatic pre-setting of gain or lag of recorded voice on a particular device will produce mixed recordings of a good quality, but for persons of above average hearing ability (as well as for studio quality recordings) the synchronization must be achieved to within a few milliseconds.

In practice, the synchronization is achieved by re-playing the recorded audio/video performance using a default synchronization value (that may be adjusted by the user in the Contestant Module), and requesting a confirmation if the synchronization is good, or offering a manual adjustment function if recording and background music are out of sync. These steps may be repeated endlessly until the user is satisfied with the recorded performance, at which stage the final composite recording may be finalized, with no further adjustment possible.

It is this composite performance track that the Competitor Module sends to the Producer Module as the Competitor's performance submission. The subject technology may thereby facilitate the creation and submission of near-studio quality recordings which are suitable for traditional media broadcasting such as television, IPTV, radio, internet radio and web-casting.

In another implementation of the system in use, the competition rules may stipulate that Contestants may invite their friends and supporters to download the Voter Module into their Device and to use the Voter Module to indicate their support for a particular Contestant's Recording.

The system may be deployed in conjunction with a telecast or broadcast competition or it may be used in a live event, for example, where the audience is in the same venue as Contestants. The audience may, once the Voter Module is installed on their Device, use those Devices to vote for Contestants in real time. This is of particular use in so-called karaoke competitions but is applicable to any event wherein Performances are conducted in a venue in front of a participatory audience.

In another implementation of the system, under the relevant contest rules, Contestants may be given a period of time in which to submit their Contestant Recording via the Contestant's Module with a pre-condition for acceptance of any Recording into the competition being criteria such as requiring a pre-determined minimum number of “votes” via the Voter Module (following presentation of the Recording to all audience members) as a pre-condition for the particular Contestant's Recording to be logged as a contender in the relevant competition.

The event or show producers may pick one or more winners from the accepted Competitor's Recordings.

In another implementation, winning Competitor's Recordings may be announced in a given episode and the relevant Competitor's Recordings may be reproduced on the event or show's homepage or in other media or transmitted to the Audience electronically or within the place wherein the event is being held.

In another implementation of the subject technology, the cumulative votes for each Competitor's Recordings may be publicized as part of an on-going competition. The data for this may be updated in real time as votes are received from Voter Modules thereby enabling viewers to see the scores in real time and be able to campaign more for their preferred Competitor's Recordings.

In another implementation of the subject technology, specific geographic regions or organizations may compete with each other by submitting Competitor Recordings—submission being facilitated by use of the Contestant Module, which enables Competitors to submit from any location at any time and for information as to the submission to be obtained and logged.

In such submissions, the Contestant would typically be required to introduce him/herself at the start of the recording plus an exhortation to the effect that the Contestant Recording is submitted for the relevant town/region or organization.

In another implementation of the subject technology, Viewers may be invited to text/email/share on Facebook or other so called Social Media sites, potential Contestant Recordings for which the particular Viewer or Viewers would garner votes if presented on the show or to the Event's Audience.

The subject technology would enable these Competitor Recordings to be identified at the source by inclusion of unique identifiers relating to each such Module distributed so that the Administrator Module can back-track each Competitor Recording should the event or program producers wish to contact the relevant Contestant, for example, to obtain necessary consents from the relevant Contestant on whose behalf the Contestant's Recording is being submitted.

In another implementation of the subject technology, Competitor's Recordings may be judged by nominated persons in real time or on a pre-recorded show and the winning Competitors then introduced to a further training and talent-enhancement process culminating in a further competition between those Competitors after they have received this training. Voters may use the Voter Module to register their preferences and the results presented real-time or at a later time.

In another implementation of the subject technology, Incumbents' performances may be presented on a website with an invitation for Competitors to submit a Competitors Recording faithfully reproducing or parodying or otherwise presenting the Incumbent's performance for Viewers to assess and vote for or against any Competitor's Recording or Recordings, using the Voting Module.

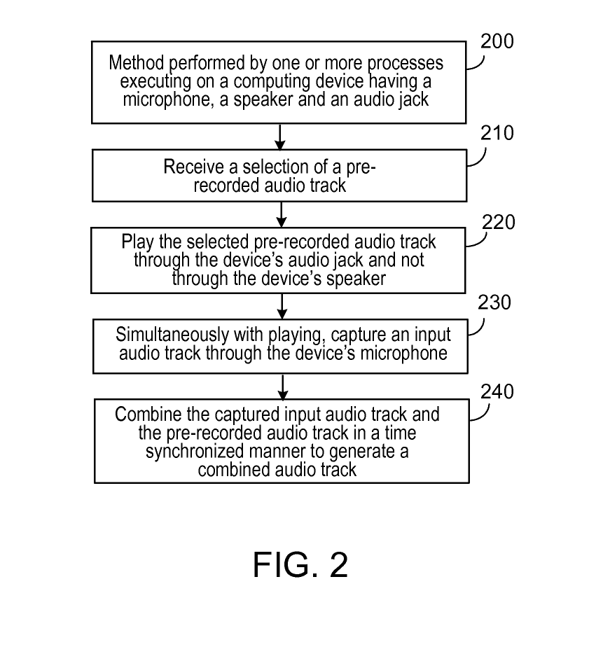

FIG. 2 is a flowchart of a method 200 performed by one or more processes executing on a computer device having at least a microphone, a speaker, an audio jack (e.g., a headphone jack), and a display screen. At 210, the device receives a selection of a pre-recorded audio track, e.g., that is displayed to the device's user on the device's display screen. At 220, the device plays the selected pre-recorded audio track through the device's audio jack and not through the device's speaker. At 230, simultaneously with playing the selected pre-recorded audio track, the device captures an input audio track through a microphone associated with the device (e.g., either a microphone integrated with the device or a separate microphone plugged into the device). As 240, the device combines the captured input audio track and the pre-recorded audio track in a time synchronized manner to generate a combined audio recording.

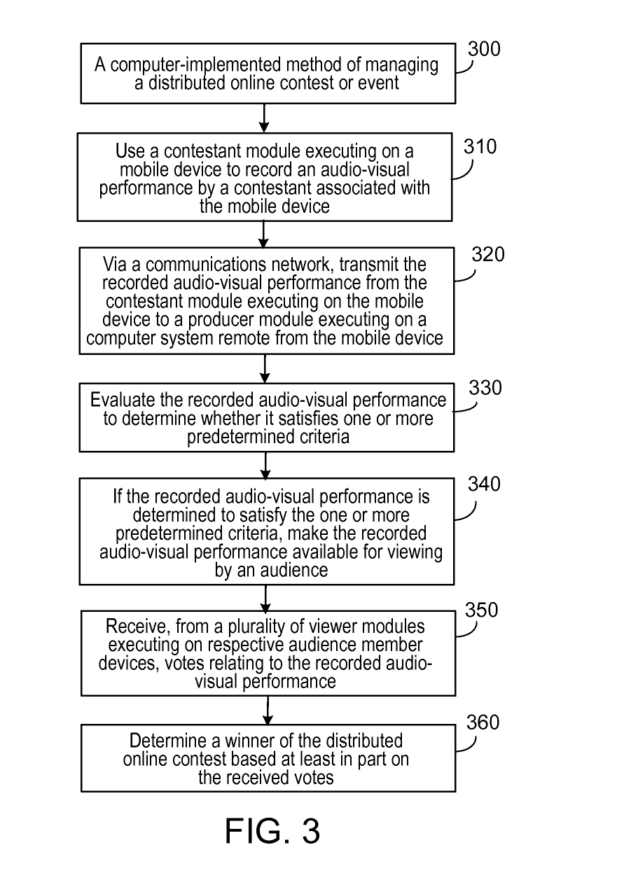

FIG. 3 is a flowchart of a computer-implemented method 300 of managing a distributed online contest or event. At 310, a contestant module executing on a mobile device is used to record an audio-visual performance by a contestant associated with the mobile device. At 320, via a communications network, the recorded audio-visual performance from the contestant module executing on the mobile device is transmitted to a producer module executing on a computer system remote from the mobile device. At 330, the recorded audio-visual performance is evaluated to determine whether it satisfies one or more predetermined criteria. At 340, if the recorded audio-visual performance is determined to satisfy the one or more predetermined criteria, the recorded audio-visual performance is made available for viewing by an audience. At 350, votes relating to the recorded audio-visual performance are received from a plurality of viewer modules executing on respective audience member devices. At 360, a winner of the distributed online contest based at least in part on the received votes is determined.

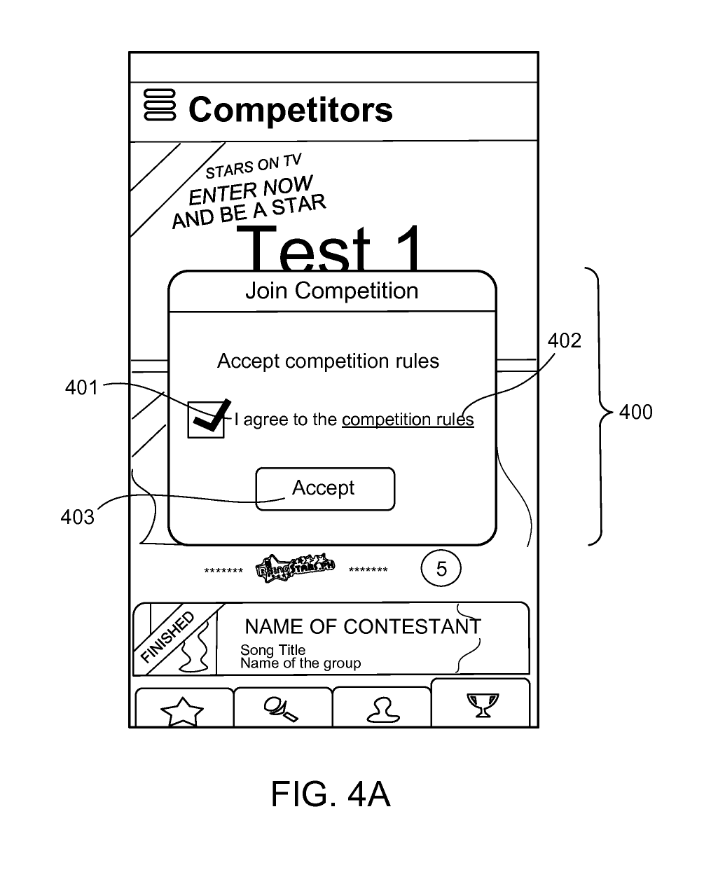

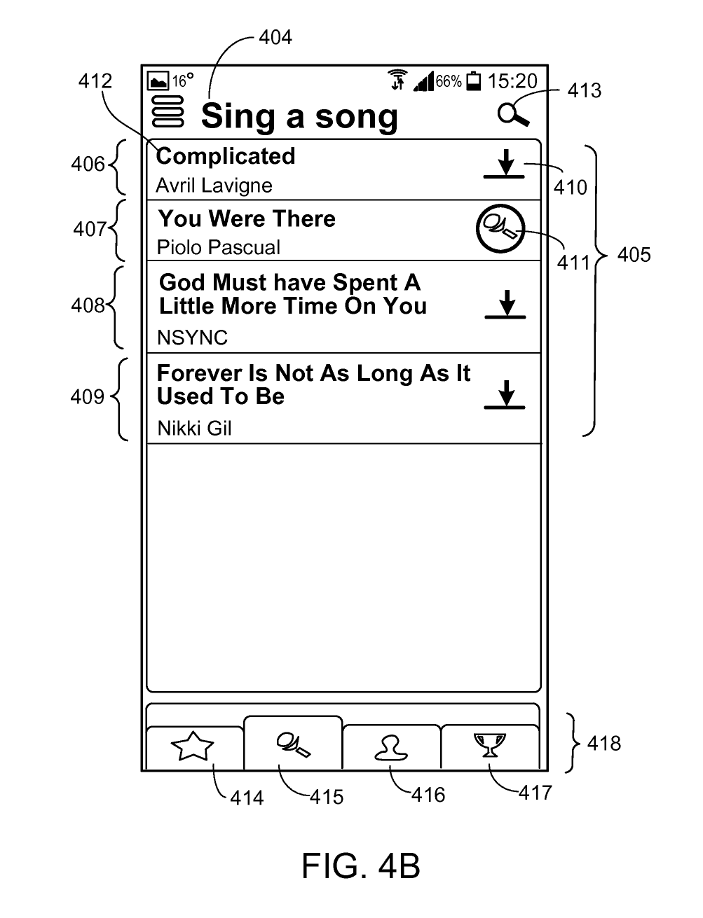

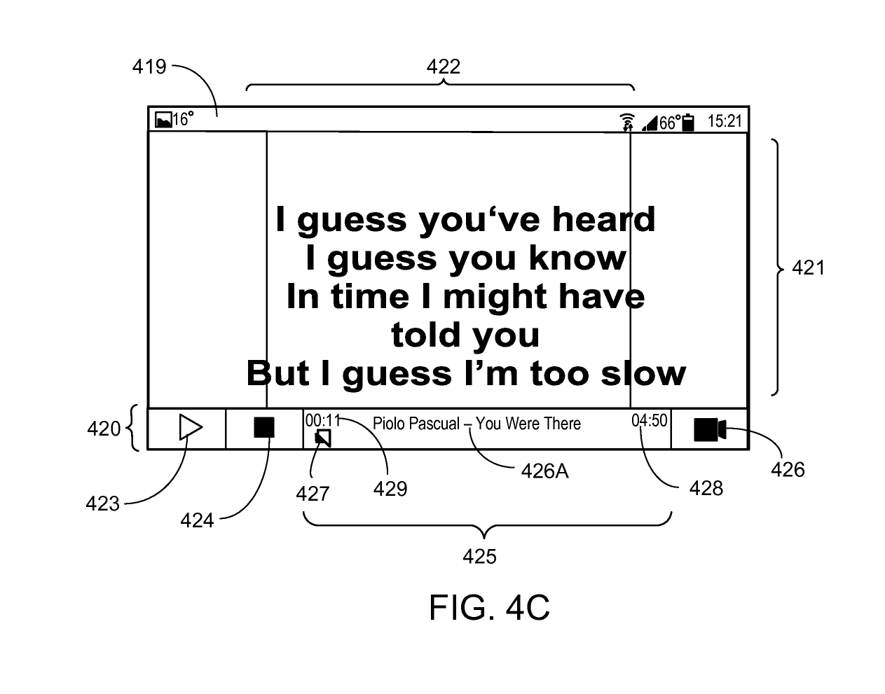

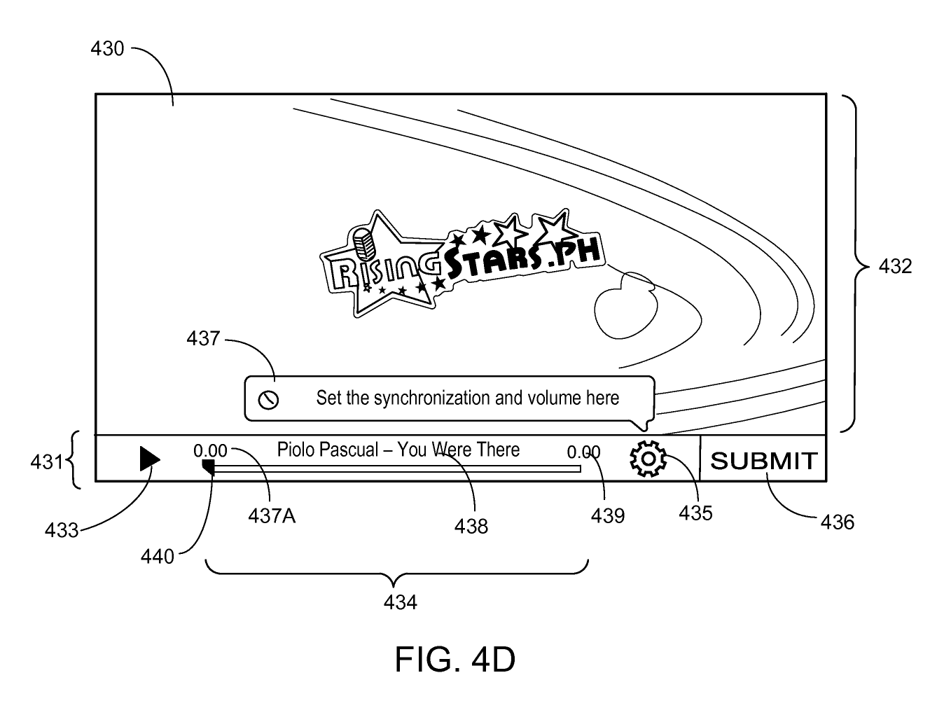

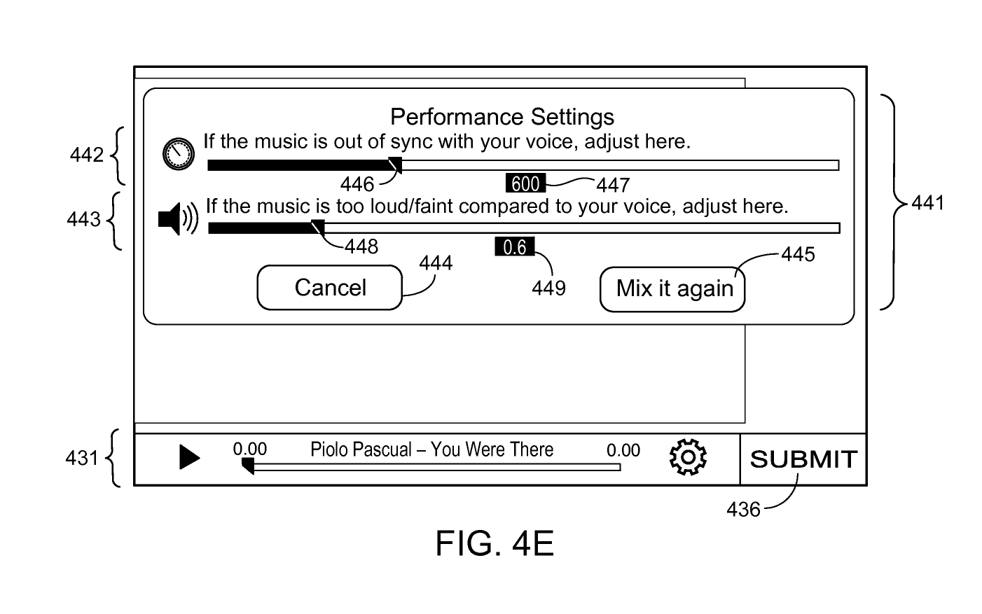

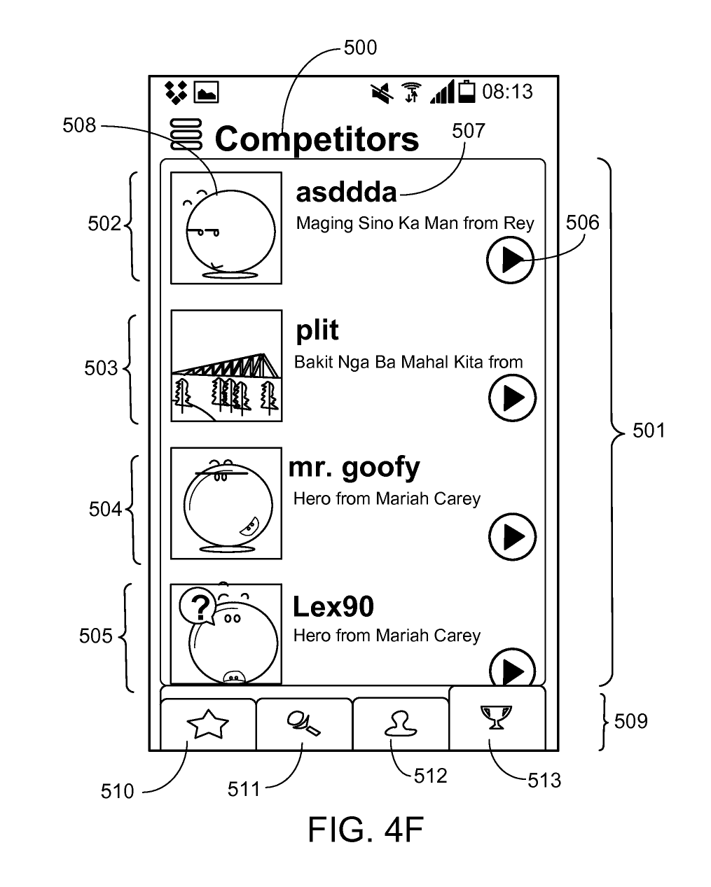

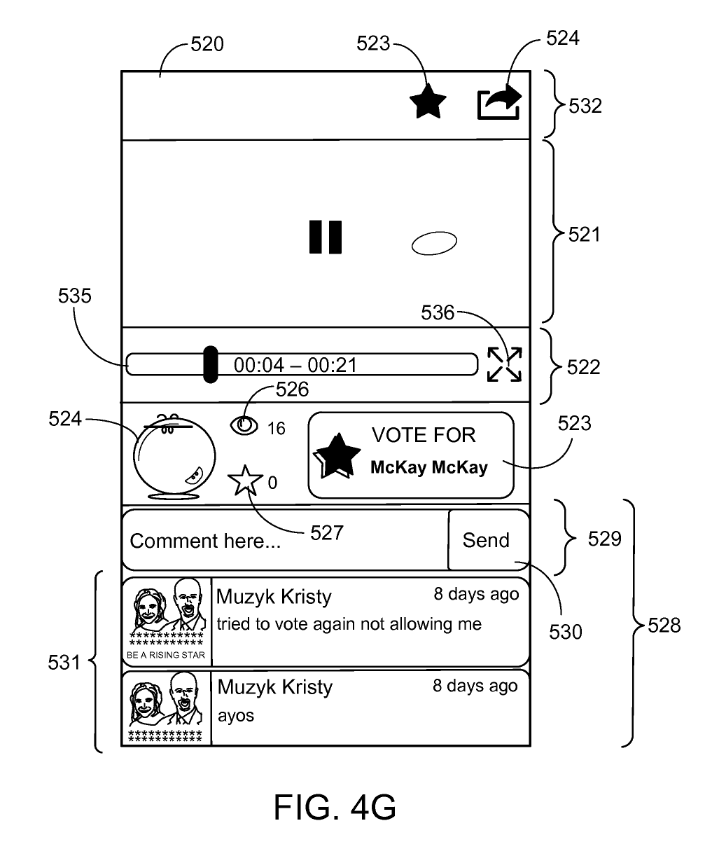

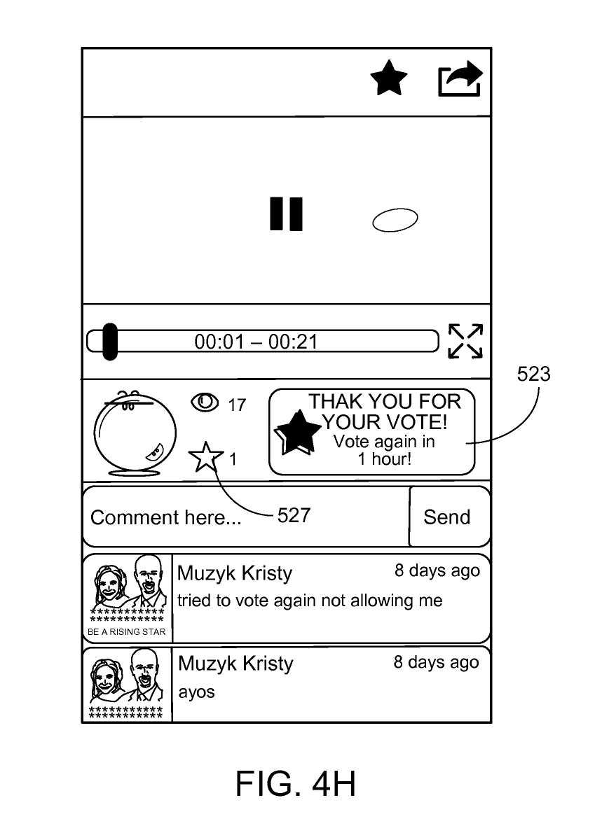

FIGS. 4A-4H are exemplary screenshots of a GUI that may be used to implement the subject technology. The GUI gives a user access to two different basic modules, a Competitor Module and a Voter Module.

The Competitor Module of the subject technology can have a GUI screen implementation as shown in the example screenshots of FIGS. 4A-4E. As shown in FIG. 4A, after launching the Competitor Module, the Contestant must first accept the Competition Rules set by the Producers on the Accept competition rules screen 400. The screen consists of an unselected tickable box 401, a link to the text of the rules 402 and an Accept button 403. The contestant must tick the 401 box and press the 403 button to accept the rules. Reading the rules by following the 402 is optional. If the 401 box is left unticked, the 403 Accept button is not active, and continuation is not possible. This combination of tick box and accept button ensures that the rules cannot be accepted by accidentally touching the screen, only by a conscious action on behalf the Contestant. After accepting the Competition Rules the Contestant is taken to the Song Selection screen as shown in FIG. 4B.

As shown in FIG. 4B, the Song Selection Screen 404 of the Competitor Module has a region 405 for the display of performances available for recording and submission to the Competition as determined by the Producers (e.g., Complicated, You were There). Each performance is represented by a separate graphical region 406, 407, 408, 409. Each region, e.g., region 404, includes a song title 412 and either a download icon 410 or a microphone icon 411. The download icon 410 signifies that the song is available for recording, while the microphone icon 411 signifies that the song is already downloaded to the device and is available for immediate recording. By pressing the 410 download icon the music and lyrics of the selected song will be downloaded to the device from the Producer Module of the subject system provided an internet connection is available. Once download is complete, the download icon 410 will change to the microphone icon 411. By pressing the microphone icon 411 the Contestant will be taken to the Record Performance screen as shown in FIG. 4C.

As further shown in FIG. 4B, the Song Selection screen 404 also has a search icon 413 which if pressed prompts a text box which may be used to enter any song title (or part of it), and the search function will refresh the 404 Song Selection page to list only those songs that match the search phrase. The Song Selection screen 404 also includes a row of clickable buttons 418 that are uniform to all screens of the subject system, denoting the available modules and permitting the switching between modules. Button 415 is slightly enlarged, denoting that the Competitor Module (for recording and joining a competition) is active. Button 414 activates the Voter Module, 416 will open the personal profile and preferences screen, while 417 opens a screen where past contest performances may be viewed.

As shown in FIG. 4C, the Record Performance screen 419 consists of a narrow function bar 420 at the bottom with the control and information functions of the screen. The controls are the start button 423, stop button 424, camera icon 426, information is provided by the progress bar 425. The largest part of the Record Performance screen is taken up by the lyrics display 421 which is semi-transparent, in order for the video display 422 to be visible behind it.

To record a performance, the Contestant must decide whether to record with or without video. The default state is with video, by pressing the camera icon 426 the video camera is de-activated and no video will be recorded. If the camera is not active, pressing the camera icon 426 will make it active again.

To start recording, the play button 423 must be pressed, which is displayed with a red background while the recording has not yet started, while the inactive stop button 424 is with a green background. Once the play button 423 is pressed and the performance recording starts, the play button will become inactive, change to a green background, and the stop button 424 will change to a red background and become active. During recording if the stop button 424 is pressed, the recording will stop and the performance finalization screen as shown in FIG. 4D will appear. If the performance is recorded till the end of the audio feed, the finalization screen will appear automatically without the need to press the stop button 424.

During recording, the progress bar 425 will show all relevant information. The timer display 427 will show the elapsed recording time (0:00 if the recording has not started, the title display 426A shows the song title, the performance length display 428 shows the total length of the song (static), and the progress marker 429 moves along the bottom of the progress bar 425 to graphically indicate the progress of the recording (elapsed time) along the total song length.

When the play button 423 is pressed, the Contestant Module starts playing the audio soundtrack of the song on the headphones connected to the device, while simultaneously displaying the lyrics of the song in large letters on a transparent background in the lyrics display 421, and also displaying the video capture from the device camera behind the lyrics display 421, in the video display 422. Any sound produced by the Contestant will simultaneously be recorded by the microphone of the Device. While the song and lyrics are being played, the Contestant Module captures a synchronized audio/video file from the Device microphone and camera outputs. At this stage this captured audio/video file does not contain the original music score of the song that was played on the headphones.

As shown in FIG. 4D, once the recording is completed either by pressing the stop button 424 or reaching the end of the original music score, the system will load the performance finalization screen 430. This screen consists of a narrow function bar 431 at the bottom with the control and information functions of the screen. The controls are the start button 433, settings icon 435, submit button 436, and information is provided by the progress bar 434. The largest part of the Record Performance screen is taken up by the playback display 432, which also contains a text bubble 437 pointing to the settings icon 435, drawing contestant's attention to adjust the synchronization/volume settings if the recording is unsatisfactory.

By pressing the play button 433 the Contestant Module will replay the recorded audio/video file while simultaneously mixing the music of the original score that was played in the headset during recording (during playback, headset is optional, if the headset is removed the mixed sound will be channeled to the default device speaker). During playback the status bar 434 will show all relevant information. The timer display 437A will show the elapsed playback time (0:00 if the playback has not started, the title display 438 shows the song title, the performance length display 439 shows the length of the recording, and the progress marker 440 moves along the bottom of the progress bar 434 to graphically indicate the progress of the recording (elapsed time) along the total song length. Pressing the settings icon 435 or the submit button 436 will stop the playback and invoke the respective functionalities.

During playback the recorded video is displayed in the playback display 432, while the mixed music and recorded audio is played back on the default device speaker (or headset connected via the device's audio jack). The recorded audio and video feeds from the device microphone (or external microphone connected to the device) and camera are hardware synchronized and need no adjustment, but due to inherent limitations in Device hardware and processing capabilities, the beginning of the recorded audio will not necessarily be fully in synch with the beginning of the played music, but may have a sight lag (usually never gain). This lag will be device specific, but also may be affected by other applications and features running on the device. During playback the Contestant will be able to evaluate the quality of the recording, specifically whether the singing voice and the soundtrack music are in synch or need lag or gain adjustment, and whether the relative volume of the recorded voice is appropriate for the volume of the soundtrack music, or too loud or too faint (depending on how far the microphone was from the singer's mouth). During professional recording sessions these parameters are carefully controlled by studio equipment, and their adjustability is key to producing studio-quality recordings.

If the Contestant is dissatisfied with any of the parameters, by pressing the settings icon 435 the Performance Settings display as shown in FIG. 4E will pop up over the playback display 432 of the performance finalization screen 430. While the Performance Settings display 441 is active, the function bar 431 will remain disabled. The Performance settings display 441 contains two settings areas, synchronization setting 442 and volume setting 443. Underneath there are the cancel button 444 which closes the screen without any adjustments and Mix again button 445.

The synchronization setting 442 and volume setting 443 have a similar appearance with a horizontal line with an adjustment bars 446, 448 visualizing the settings, while numeric displays 447, 449 providing numeric display of set values. By pulling the adjustment bars 446, 448 along the horizontal line the setting values are moved back and forth.

Default synchronization value is pre-set in the Contestant Module to be 600 milliseconds, meaning that during mixing the recorded audio/video file will start 600 milliseconds after the start of the original soundtrack file (this value having been found to be a good approximation for average handheld Devices for this particular implementation). If the Contestant finds that in the mixed playback the voice still lags behind the music, the setting bar 446 will need to be pulled to the right, with corresponding lag value displayed in numeric display 447. Similarly if the voice is preceding the music, the setting bar 446 needs to be pulled left.

Default volume setting value is pre-set in the Contestant Module to be zero, meaning that microphone output volume is not adjusted during mixing. If the Contestant finds that in the mixed playback the voice volume is low compared to the music, the setting bar 448 will need to be pulled to the right to make the voice louder, with the corresponding relative volume displayed in numeric display 449. Similarly if the voice is too loud compared to the music, the setting bar 448 needs to be pulled left.

Once the settings are adjusted, by pressing the Mix again button 445 the settings will be stored as the new default, the Performance Settings screen 441 will close and the Performance Finalization screen 430 functions will become active again. The playback/adjust settings steps may be repeated indefinitely until the results are satisfactory. Once the recording is considered suitable for a Contest entry, by pressing the Submit button 436 the recorded and fully mixed performance is uploaded as a single audio/video file to the Producer Module (provided an internet connection exists).

The Voter Module of the subject technology can have a GUI screen implementation as shown in the example screenshots of FIGS. 4F-4H.

As shown in FIG. 4F, the Competitors screen 500 of the Voter Module has a region 501 for display of performances recorded by various Competitors (e.g., asddda, plit, mr.goofy, Lex90). Each performance is represented by a separate graphical region 502, 503, 504, 505. Each region, e.g., region 502, includes an avatar 508 and a name 507 associated with the Competitor who submitted the performance in question. The user of the device displaying the Competitors screen 500 can listen to and view (if both audio and video) that Competitor's performance by clicking on the Play Button 506.

The Competitors screen 500 also includes a row of clickable buttons 509 that is uniform to all screens of the subject system, denoting the available modules and permitting switching between modules. Button 513 is slightly enlarged, denoting that the Voter Module (for viewing, sharing and voting for performances in a competition) is active. Button 510 activates the Favorites list (a narrowed down version of the Voter Module), Button 511 activates the Competitor Module (to join the contest with a performance), and 512 will open the personal profile and preferences screen.

As shown in FIG. 4G the play button will open the Viewing/voting screen 520 which enables the viewing and interactions with a particular performance/performer. The upper part of the screen consists of a playback display 521 and associated status bar 522. On opening the Viewing screen 520 the selected performance will automatically start playing in the display 521 while the associated audio stream will play on the default speaker of the Device. Moveable progress marker 535 will show the progress of the playback, and by moving it one may skip to any part of the performance. Reaching the end of the performance playback will stop unless progress marker is moved to beginning of performance. By pressing full screen icon 536 the playback display will fill the available screen removing all other screen features until full screen icon 536 is pressed again to restore Viewing/Voting screen 520 functionalities.

Above the playback window 521 there is the social functions bar 532 with a favorites (star) icon 523 and a share icon 534. Pressing the favorites icon 523 will add performance to favorites list, easily accessible by pressing button 510 from all main screens of the subject system. The Favorites list is a reduced iteration of the Voter Module, with only performances marked as favorite appearing in the list, not all performances submitted to a particular Contest.

If the Producers of the Contest so permit in the Contest Rules, the Share Button 534 enables the sharing of the performance through the Producer Module to various social networking sites (e.g., Facebook, Twitter).

Under the status bar 522 at left there is a prominent performer avatar 524, flanked by an icon (eye) and numeric display 526 denoting number of views and icon (star) and numeric display 527 denoting number of votes for the displayed performance.

Under the status bar 522 at right there is a prominent Vote button 523 that calls for a vote for the performer (performer name displayed on Button). By pressing the vote button 523 a vote will be added to the vote count 527, and the text of the vote button 523 will change to displaying “Thank you for your vote” and displaying when the user may vote again for the performance, as shown in FIG. 4H. (The number of votes for a performance per voter may be set from the Producer Module corresponding to Contest rules, and may be any number from one vote per every 5 minutes to one vote per 24 hours). Should the Vote button 523 be pressed again, the text “You may only vote again after [time left to vote]” is displayed for five seconds, where the time left may be expressed in minutes or hours. Once the user is eligible to vote again, the Vote button will revert to the text and form as shown in FIG. 4G.

The lower part of the Viewing/voting screen is taken up by the Comment area 528, consisting of a text entry box 529 where a comment may be entered, a send button 530 to confirm and save entered comment, and a comment history display 531 showing a scrollable list of previous comments.

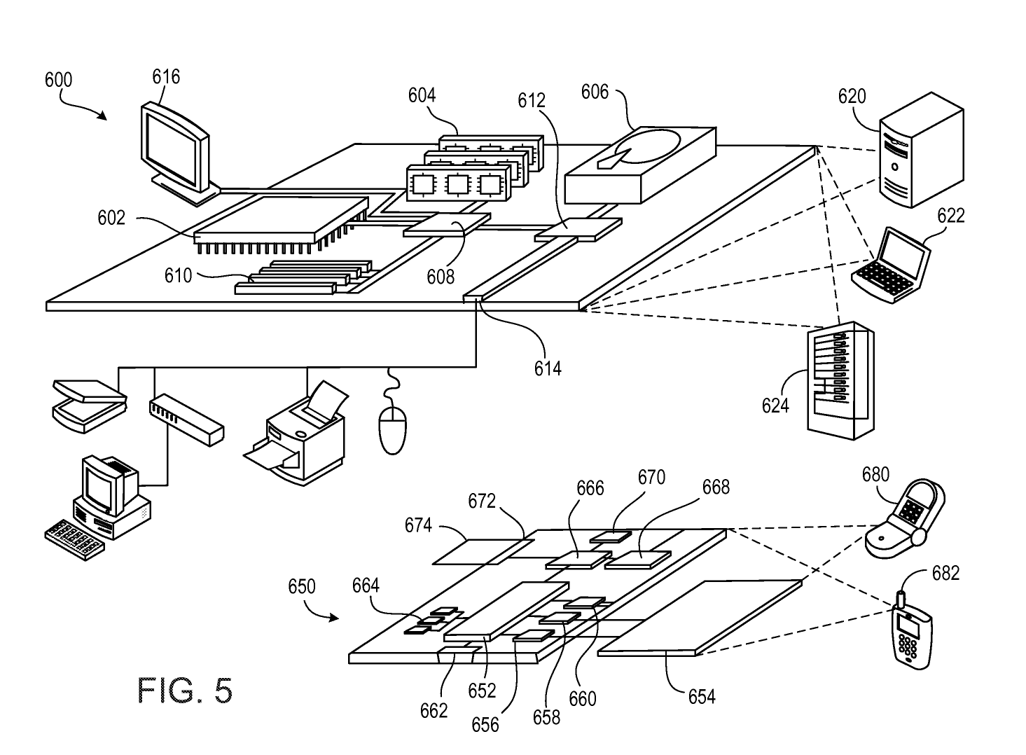

FIG. 5 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. Additionally computing device 600 or 650 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. Additionally, the processor may be implemented using any of a number of architectures. For example, the processor 610 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652 that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A method performed by one or more processes executing on a computing device having at least a speaker, an audio jack, and a display screen, the method comprising:
receiving a selection of a pre-recorded audio tracks complete with synchronized lyrics in text format displayed on the device's display screen;
playing the selected pre-recorded audio track through the device's audio jack and not through the device's speaker;
simultaneously with the playing, capturing an input audio track through a microphone associated with the device; and
combining the captured input audio track and the pre-recorded audio track in a time synchronized manner to generate a combined audio recording.

2. The method of claim 1 wherein playing the selected pre-recorded audio track through the device's audio jack comprising playing the selected pre-recorded audio track through headphones connected to the device's audio jack.

3. The method of claim 1 further comprising entering a talent contest by transmitting the combined audio recording to a remote server via the Internet.

4. The method of claim 1 wherein combining the captured input audio track and the pre-recorded audio track in a time synchronized manner comprises synchronizing the captured input audio track with the played pre-recorded audio track such that an utterance in the captured input audio track is matched with a portion of the pre-recorded audio track that was playing at a same time as the utterance was made.

5. The method of claim 1 wherein the combining occurs after the input audio track has been captured.

6. The method of claim 1 wherein the combining occurs at least in part simultaneously with capturing of the input audio track.

7. The method of claim 1 wherein the microphone associated with the device comprises a microphone integrated into the device.

8. The method of claim 1 wherein the microphone associated with the device comprises an external microphone connected to the device.

9. The method of claim 1 wherein the device further comprises a transceiver, and the method further comprises transmitting the combined audio recording to a remote computer system as an entry into a talent contest.

10. The method of claim 1 further comprising, simultaneously with playing the pre-recorded audio track, displaying scrolling lyrics on the device's display screen such that the displayed lyrics and the pre-recorded audio track are time synchronized.

11. The method of claim 1 further comprising, simultaneously with capturing the input audio track, capturing an input video track using a camera associated with the device.

12. The method of claim 11 wherein the combining comprises combining the captured input audio track, the captured video track, and the pre-recorded audio track in a time synchronized manner to generate a combined audio-visual recording.

13. A non-transitory medium comprising computer-readable instructions that when executed by a computer system cause operations to be performed including the following:
receiving, by a device having at least an audio jack, a speaker, and a display screen, a selection of a pre-recorded audio track displayed on the device's display screen;
playing the selected pre-recorded audio track through the device's audio jack and not through the device's speaker;
simultaneously with the playing, capturing an input audio track through a microphone associated with the device; and
combining the captured input audio track and the pre-recorded audio track in a time synchronized manner to generate a combined audio recording.

14. The medium of claim 13 wherein playing the selected pre-recorded audio track through the device's audio jack comprising playing the selected pre-recorded audio track through headphones connected to the device's audio jack.

15. The medium of claim 13 further comprising entering a talent contest by transmitting the combined audio recording to a remote server via the Internet.

16. The medium of claim 13 wherein combining the captured input audio track and the pre-recorded audio track in a time synchronized manner comprises synchronizing the captured input audio track with the played pre-recorded audio track such that an utterance in the captured input audio track is matched with a portion of the pre-recorded audio track that was playing at a same time as the utterance was made.

17. The medium of claim 13 wherein the combining occurs after the input audio track has been captured.

18. The medium of claim 13 wherein the combining occurs at least in part simultaneously with capturing of the input audio track.

19. The medium of claim 13 wherein the microphone associated with the device comprises a microphone integrated into the device.

20. The medium of claim 13 wherein the microphone associated with the device comprises an external microphone connected to the device.

21. The medium of claim 13 wherein the device further comprises a transceiver, and the medium further comprises instructions to cause the device to transmit the combined audio recording to a remote computer system as an entry into a talent contest.

22. The medium of claim 13 further comprising, simultaneously with playing the pre-recorded audio track, displaying scrolling lyrics on the device's display screen such that the displayed lyrics and the pre-recorded audio track are time synchronized.

23. The medium of claim 13 further comprising, simultaneously with capturing the input audio track, capturing an input video track using a camera associated with the device.

24. The medium of claim 23 wherein the combining comprises combining the captured input audio track, the captured video track, and the pre-recorded audio track in a time synchronized manner to generate a combined audio-visual recording.

25. A computer-implemented method of managing a distributed online contest or event, the method comprising:
using a contestant module executing on a mobile device to record an audio-visual performance by a contestant associated with the mobile device;
via a communications network, transmitting the recorded audio-visual performance from the contestant module executing on the mobile device to a producer module executing on a computer system remote from the mobile device;
evaluating the recorded audio-visual performance to determine whether it satisfies one or more predetermined criteria;
if the recorded audio-visual performance is determined to satisfy the one or more predetermined criteria, making the recorded audio-visual performance available for viewing by an audience;
receiving, from a plurality of viewer modules executing on respective audience member devices, votes relating to the recorded audio-visual performance; and
determining a winner of the distributed online contest based at least in part on the received votes.
